(19) United States
(12) Patent Application Publication
(10) Pub. No.: US 2013/0237248 A1
(43) Pub. Date: Sep. 12, 2013

(54) APPARATUS AND METHOD FOR PROVIDING LOCATION INFORMATION

(71) Applicants: Kyong-Ha Park, Suwon-Si (KR); Gye-Joong Shin, Seongnam-si (KR); Hyun-Su Hong, Seongnam-si (KR); Sung-Min Park, Seoul (KR); Ji-Heon Oh, Gyeonggi-do (KR)

(72) Inventors: Kyong-Ha Park, Suwon-Si (KR); Gye-Joong Shin, Seongnam-si (KR); Hyun-Su Hong, Seongnam-si (KR); Sung-Min Park, Seoul (KR); Ji-Heon Oh, Gyeonggi-do (KR)

(21) Appl. No.: 13/989,700

(22) PCT Filed: Nov. 24, 2011
(86) PCT No.: PCT/KR11/09037

§ 371 Date: May 24, 2013

(30) Foreign Application Priority Data
Nov. 25, 2010 (KR) 10 2010-0118349

(51) Int. Cl. H04W 24/00

(52) U.S. Cl. CPC H04W 24/00
USPC 455/456.1

(57) ABSTRACT

A method and apparatus for providing location information are provided. The method includes estimating location information is estimated, calculating an error value of the estimated location information, controlling activation of a location determination module according to the error value, and providing location information using at least one of the estimated location information and location information determined by the location determination module.

### PRIORITY

This application is a National Stage application under 35 U.S.C. §371 of an International application filed on Nov. 24, 2011 and assigned application No. PCT/KR2011/009037, and claims the benefit under 35 U.S.C. §365(b) of a Korean patent application filed on Nov. 25, 2010 in the Korean Intellectual Property Office and assigned Serial No. 10-2010-0118349, the entire disclosures of which is hereby incorporated by reference.

### BACKGROUND OF THE INVENTION

1. Field of the Invention

The present invention relates to navigation technology. More particularly, the present invention relates to a method and apparatus for determining location information in a Global Positioning System (GPS) shadowing area.

2. Description of the Related Art

A user navigation system uses location information received from a GPS. However, when a user enters a GPS shadowing area in which a GPS signal cannot be received, the user's location in the shadowing area is estimated based on valid GPS location information that was used before the user entered the shadowing area.

During a time period in which the user stays in the GPS shadowing area, a user navigation system of the related art provides location information estimated through Pedestrian Dead Reckoning (PDR) or limited location information based on a predetermined time and distance after the user enters the GPS shadowing area until the user moves out of the GPS shadowing area and thus again receives valid GPS location information. Alternatively, the user navigation system of the related art locates the user in the GPS shadowing area and provides the user's location information using a Wireless Fidelity (Wi-Fi) Positioning System (WPS) that determines a user's location using information regarding a wireless Access Point (AP) from a Wi-Fi signal or a cell-based location information measuring system.

In general, the GPS needs to monitor satellite signals every predetermined time unit (e.g. every second) in order to continuously update a user's location information. Especially in a GPS shadowing area, the GPS continuously monitors satellite signals to determine whether the user has moved out of the GPS shadowing area. That is, in the case where location information about a user in a GPS shadowing area is estimated through PDR, the GPS continuously monitors satellite signals every predetermined time unit (e.g. every second) even after the user enters the GPS shadowing area in order to provide location information about the user determined using GPS signals instead of the PDR-based location information when the user moves out of the GPS shadowing area and thus the user can be located. If the WPS or the cell-based location information measuring system is used for a user located in a GPS shadowing area, the WPS or the cell-based location information measuring system needs to monitor an AP signal or a Base Station (BS) signal of a mobile communication system every predetermined time unit (e.g. every second) to continuously update the location information about the user. In addition, the WPS or the cell-based location information measuring system continuously monitors satellite signals to determine whether the user has moved out of the GPS shadowing area, while monitoring the AP signal or the BS signal.

A shortcoming with the PDR-based location information determining scheme for a GPS shadowing area is that much power is consumed to monitor GPS signals. More particularly, when the WPS or the cell-based location information measuring system is used for a user located in a GPS shadowing area, much power is consumed to monitor GPS signals as well as an AP signal or a BS signal. Accordingly, there is a need for an improved apparatus and method for reducing the amount of power consumed when determining location information in a GPS shadowing area.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for remarkably reducing power consumption in determining location information.

In accordance with an aspect of the present invention, a method for providing location information is provided. The method includes estimating location information, calculating an error value of the estimated location information, controlling activation of a location determination module according to the error value, and providing location information using at least one of the estimated location information and location information determined by the location determination module.

The method may further include determining whether a user is moving using a sensor unit that senses a motion of the user, and controlling activation of the location determination module according to whether the user is moving.

In accordance with another aspect of the present invention, an apparatus for providing location information is provided. The apparatus includes a location determination module for determining location information, a motion sensor unit including at least one sensor for generating motion information representing a motion of a user, a location information estimator for estimating location information using the motion information received from the motion sensor unit and for calculating an error value of the estimated location information, and a controller for controlling activation of a location determination module according to the error value and for controlling provision of location information using at least one of the location information received from the location information estimator and the location information determined by the location determination module.

The controller may determine whether the user is moving based on the motion information received from the motion sensor unit and may control activation of the location determination module according to the determination.

According to the method and apparatus for determining location information of the present invention, power consumption can be remarkably reduced for determining location information.

In addition, if a Global Positioning System (GPS) shadowing area in which a user terminal is located has a relatively high GPS positioning accuracy, the location of the user terminal is estimated while the GPS module is off. Thus, power consumption can be significantly reduced for determining location information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

The above and other objects, features, and advantages of certain exemplary embodiments of the present invention will be more apparent from the following description taken in conjunction with the accompanying drawings, in which:

FIG. 1 is a block diagram of a portable terminal having an apparatus for providing location information according to an exemplary embodiment of the present invention;

FIG. 2 is a flowchart illustrating a method for providing location information according to an exemplary embodiment of the present invention;

FIG. 3 is a flowchart illustrating a method for providing location information according to another exemplary embodiment of the present invention;

FIG. 4 is a flowchart illustrating a method for providing location information according to another exemplary embodiment of the present invention; and

FIG. 5 is a flowchart illustrating a method for providing location information according to a further exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to exemplary embodiments of the present invention, Global Positioning System (GPS) location information refers to information indicating the location of a user terminal determined based on data received from a GPS. Location information refers to information indicating the location of the user terminal estimated using information received from an acceleration sensor and a geomagnetic sensor. Indoor location information refers to information indicating the location of the user terminal determined by a Wireless Fidelity (Wi-Fi) Positioning System (WPS) module, a cell-based location information providing module that provides location information based on a cell of a mobile communication network, or a sensor-based location information providing module that provides location information using Bluetooth, ZigBee, an infrared sensor, an ultrasonic sensor, a Radio Frequency IDenification (RFID) sensor, etc.

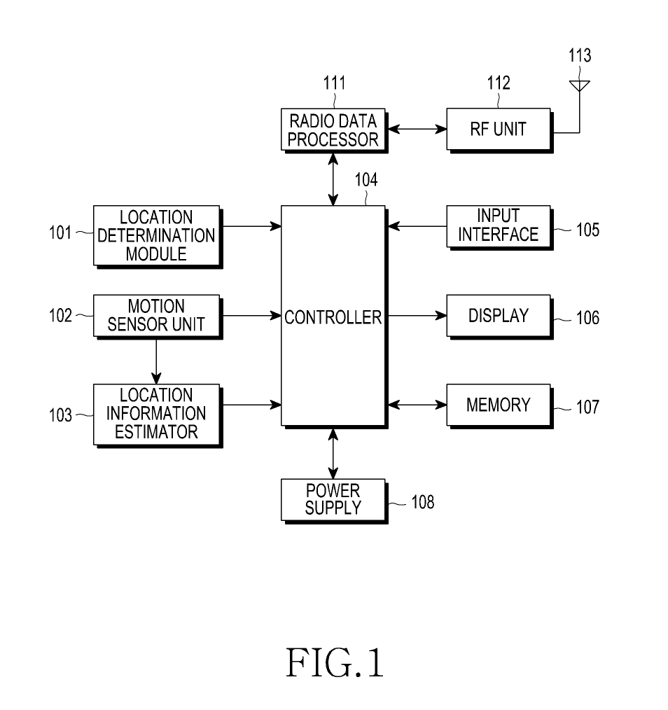

FIG. 1 is a block diagram of a portable terminal having an apparatus for providing location information according to an exemplary embodiment of the present invention. A description will first be given of a hardware device to which the present invention can be applied, taking a mobile communication terminal as an example, from among various devices equipped with the location information providing apparatus of the present invention. While it is described that the location information providing apparatus resides in a mobile communication terminal, this is purely exemplary. Thus, it is to be understood that the location information providing apparatus of the present invention is also applicable to any of various devices that provide location information.

Referring to FIG. 1, the portable terminal having the location information providing apparatus includes a location determination module 101, a motion sensor unit 102, a location information estimator 103, a controller 104, an input interface 105, a display 106, and a memory 107.

The location determination module 101 has a GPS module for receiving location information from a GPS and providing the received location information.

Although not illustrated in FIG. 1, the location determination module 101 may further include a WPS module for determining location information using wireless Access Point (AP) information received by Wi-Fi, a cell-based location information providing module for providing location information based on a cell of a mobile communication network, and a sensor-based location information providing module for providing location information about a user terminal using Bluetooth, ZigBee, an infrared sensor, an ultrasonic sensor, a Radio Frequency IDenification (RFID) sensor, etc.

The motion sensor unit 102 senses information needed to estimate location information about a user in a shadowing area and the accuracy of the estimated location information. The motion sensor unit 102 may include an acceleration sensor for sensing the acceleration of the user terminal to detect the velocity of the user terminal, a geomagnetic sensor for sensing the azimuth angle of the user needed to estimate the heading of the user, an altitude sensor for sensing the altitude of the user, a gyro sensor for sensing the angular velocity of the user, and the like.

The location information estimator 103 determines terminal movement information containing information about the velocity and heading of the user terminal using information received from the acceleration sensor and the geomagnetic sensor of the motion sensor unit 102 in every predetermined period. That is, the location information estimator 103 determines the movement state of the user terminal and calculates the velocity of the user, using the information received from the acceleration sensor, and acquires information about the validity of geomagnetic sensor data and azimuth angle information from the information received from the geomagnetic sensor. The location information estimator 103 estimates current location information about the user by considering the azimuth angle information and velocity information with respect to the estimated heading of the user in GPS location information stored in the memory 107.

In addition, the location information estimator 103 estimates the error of the estimated location information taking into account auxiliary location information including information about the movement state of the user terminal, the validity of geomagnetic sensor data, and the velocity of the user or user terminal. The error may be an accumulated error value that may be generated during estimation of the location information.

More specifically, the error of the estimated location information may be calculated taking into account the movement state of the user terminal, the validity of a geomagnetic sensor output, the velocity of the user, the velocity variance of the user, a time interval between error calculations, the error of each sensor, a moving time of the user in a shadowing area, a variation in the angular velocity of the gyro sensor, an altitude variation, etc.

The movement state of the user terminal indicates whether the user terminal is parallel or perpendicular to the ground. The azimuth angle information acquired from the geomagnetic sensor is not relatively erroneous in the former case, while it has a relatively large error in the latter case. Therefore, a different error rate is set according to the movement state of the user terminal. In accordance with an exemplary embodiment of the present invention, the state in which the user terminal is parallel to the ground is not restricted to its literal meaning. Rather, it covers a state in which the user terminal is approximately parallel to the ground, for the purpose of determining an error in the azimuth angle of the geomagnetic sensor in the user terminal. Likewise, the state in which the user terminal is perpendicular to the ground is not restricted to its literal meaning. Rather, it covers a state in which the user terminal is approximately perpendicular to the ground in the exemplary embodiment of the present invention.

The geomagnetic sensor outputs azimuth angle information by sensing the magnetic field of the earth. The azimuth angle information may have an error depending on the state of the electromagnetic field of an environment in which the geomagnetic sensor is placed. Thus, the location information estimator 103 determines the validity of data output from the geomagnetic sensor by monitoring the current state of the geomagnetic sensor in real time and applies a different error rate according to the state of the geomagnetic sensor when location information is estimated.

As the user terminal moves at a higher velocity, it moves a longer distance per unit time. As a result, the movement distance of the user terminal may vary according to the velocity of the user terminal. Hence, a different error rate may be applied for a different velocity. The location information estimator 103 measures the velocity of the user terminal using the acceleration sensor and applies a different error rate based on the velocity measurement. For example, if the velocity is high, a relatively high error rate is set, as compared to a low velocity.

Because the user terminal may continue moving or may be stationary after moving a specific distance, the auxiliary location information may further include a velocity variance. Thus, the location information estimator 103 further calculates the variance of the velocity and corrects the error rate of the velocity using the velocity variance, when the user terminal continues moving.

As a predetermined period in which the location information is estimated is longer, information acquired from the sensors is not immediately reflected. Instead, the average of the acquired information is reflected, thereby increasing the error of an estimated location. Therefore, the location information estimator 103 determines the length of the predetermined period and applies a different error rate according to the length of the predetermined period.

The location information estimator 103 may calculate the error of the estimated location information by further reflecting the errors of the sensors of the motion sensor unit 102. To increase the error of an estimated location in a situation where the movement of the user is not detected (e.g. in an elevator, on an escalator, etc.), the location information estimator 103 may estimate the error by further reflecting the moving time of the user. The location information estimator 103 may correct the azimuth angle information of the geomagnetic sensor that rapidly changes according to an ambient environment by determining a variation in the angular velocity information of the gyro sensor. Furthermore, to measure an altitude variation that occurs during the user's movement on e.g., an elevator, an escalator, a stairway, etc. in a shadowing area, the location information estimator 103 may calculate the error, taking into account the altitude variation of the user by determining altitude information from the altitude sensor.

The controller 104 provides control of the user terminal by controlling the above described functions. More specifically, the controller 104 processes a number and a menu selection signal received from the input interface 105, processes location information received from the location determination module 101, and outputs the location information together with a map stored in the memory 107 on the display 106.

In an exemplary implementation, the controller 104 receives information about the reception sensitivity of location information received from the GPS module of the location determination module 101, for example, the number of available GPS satellites and the received signal strengths of GPS satellite signals. Based on the reception sensitivity of the location information, the controller 104 determines whether the user terminal is located in a shadowing area. If the controller 104 determines that the user terminal is located in a shadowing area, the controller 104 controls activation of the motion sensor unit 102 and the location information estimator 103.

The controller 104 may also determine whether the user is moving using information received from the motion sensor unit 102. Because the location information determination module 101 may operate unnecessarily while the user is stationary, the controller 104 may determine whether the user is moving and may control activation of the location information determination module, taking into account whether the user is moving.

The input interface 105 receives a phone number or characters from the user. The input interface 105 includes alphanumerical keys for entering digits, characters, and function keys for setting various functions. The keys may be configured into a keypad or a touch screen-based key input interface that displays keys on a display overlapped with a touch screen and receives input of a key corresponding to a touched area.

In an exemplary implementation, the display 106 may be configured with a Liquid Crystal Display (LCD). The display 106 may display a message representing the operation state of the user terminal, data generated during execution of an application, such as location information or a map, under the control of the controller 104, and the like.

The memory 107 stores data needed to execute an application, for example, map data. Especially, the memory 107 stores location information received periodically from the location determination module 101, data received from the motion sensor unit 102, location information received from the location information estimator 103, and an error value received from the location information estimator 103.

The portable terminal having an exemplary location information providing apparatus of the present invention may further include a power supply 108 for supplying power to the function blocks 101 to 107, 111, and 112. The controller 104 may provide the power supply 108 with a control signal for controlling activation/deactivation (ON/OFF) of the location determination module 101, the motion sensor unit 102, and the location information estimator 103. The power supply 108 supplies power to the location determination module 101, the motion sensor unit 102, and the location information estimator 103 according to the control signal.

A Radio Frequency (RF) unit 112 modulates voice data, character data, and control data of the user to an RF signal and transmits the RF signal to a Base Station (BS, not shown) of a mobile communication network through an antenna 113. The RF unit 112 also receives an RF signal from the BS through the antenna 113, demodulates the received RF signal to voice data, character data, and control data, and outputs the demodulated data. A radio data processor 111 decodes the voice data received from the RF unit 112 and outputs the decoded voice data as audible sound through a speaker under the control of the controller 104. The radio data processor 111 also converts a voice signal of the user received through a microphone into voice data, outputs the voice data to the RF unit 112, and provides character data and control data received from the RF unit 112 to the controller 114.

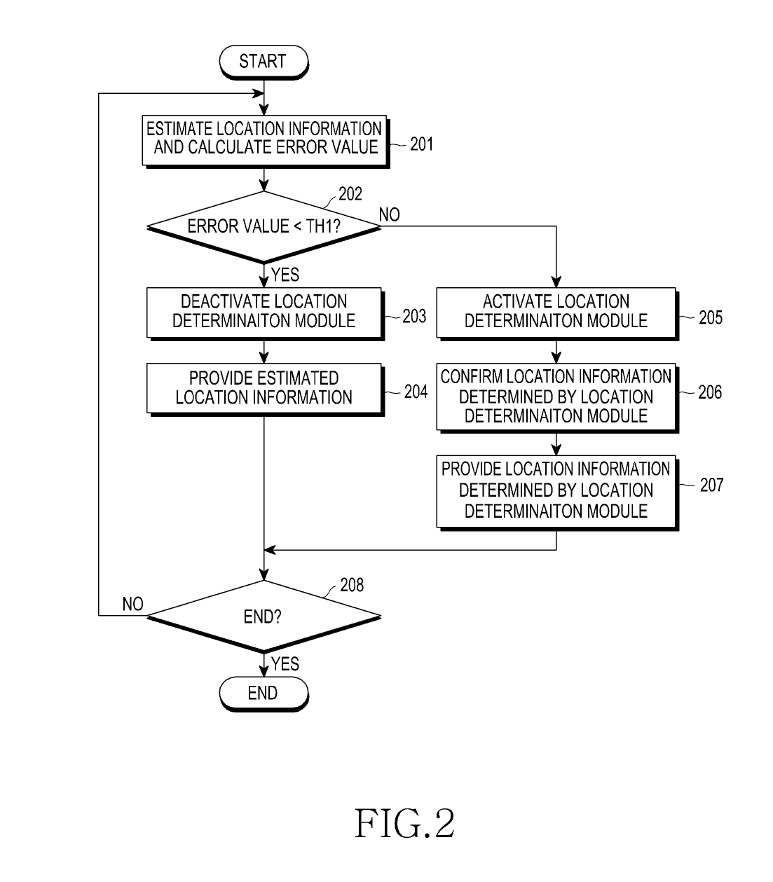

FIG. 2 is a flowchart illustrating a method for providing location information according to an exemplary embodiment of the present invention.

Referring to FIG. 2, location information is estimated and an error value of the estimated location information is calculated in step 201.

Step 201 may be performed by the location information estimator 103 in the afore-described location information providing apparatus. More specifically, location information may be estimated using information received at every predetermined interval from the acceleration sensor and the geomagnetic sensor. That is, the location information estimator 103 determines the movement state of the user terminal and calculates the velocity of the user based on information received from the acceleration sensor. In addition, the location information estimator 103 determines the heading of the user based on data validity information and azimuth angle information received from the geomagnetic sensor. Then, the location information estimator 103 estimates current location information about the user by considering the azimuth angle information and velocity information with respect to the estimated heading of the user in already-stored GPS information. The error value of the estimated location information is estimated, taking into account auxiliary location information including information about the movement state of the user terminal, the data validity of the geomagnetic sensor, and the velocity of the user or user terminal. The error value may be an accumulation of errors that may be produced during estimating of the location information. The error value may be calculated using the movement state of the user terminal, the validity of a geomagnetic sensor output, the velocity of the user, the velocity variance of the user, a time interval between error calculations, the error of each sensor, a moving time of the user in a shadowing area, a variation in the angular velocity of the gyro sensor, and an altitude variation of the user.

Step 202 may be performed by the controller 104 in the afore-described location information providing apparatus. In step 202, the controller 104 compares the error value received from the location information estimator 103 with a predetermined threshold TH1. If the error value is smaller than the threshold TH1, that is, if the answer to whether the error value is smaller than the threshold TH1 is Yes in step 202, the controller 104 outputs a control signal for deactivating the location determination module 101 and thus the location determination module 101 is deactivated in response to the control signal in step 203. On the contrary, if the error value is equal to or larger than the threshold TH1 in step 202, that is, if the answer to the question asked in step 202 is No, the controller 104 outputs a control signal for activating the location determination module 101 and thus the location determination module 101 is activated in response to the control signal in step 205.

The control signal may be provided directly to the location determination module 101 to thereby control the operation of the location determination module 101. Additionally, the control signal may be provided to the power supply 108 so that the power supply 108 may supply or cut power to the location determination module 101.

If the location determination module 101 is deactivated in step 203, the controller 104 confirms and provides the location information estimated by the location information estimator 103 in step 204. On the other hand, if the location determination module 101 is activated in step 205, the controller 104 confirms location information received from the location determination module 101 in step 206 and provides the confirmed location information in step 207.

At least one of the WPS module, the cell-based location information providing module, and the sensor-based location information providing module may be activated in the location determination module in step 205.

The location information provided in step 204 or 207 may be used for an application executed by the controller 104 or transmitted to a communication network, for use in a location information-based service.

In step 208, it is determined whether the application or the location information-based service is ended. While the application or the location information-based service is not ended, that is, when the application or the location information-based service is in progress, steps 201 to 207 are repeated.

In the location information providing method according to an exemplary embodiment of the present invention, before step 201, the controller 104 may further determine whether the user terminal is located in a shadowing area by determining the reception sensitivity of location information received from the GPS module of the location determination module 101, for example, the number of available GPS satellites and the received signal strengths of GPS satellite signals. Moreover, steps 201 to 208 may be performed only if the user terminal is located in a shadowing area.

As described before, when the user terminal is located in a shadowing area, the location determination module 101 (e.g. the GPS module, the WPS module, the cell-based location information providing module, and the sensor-based location information providing module) is selectively activated when needed, rather than it being continuously operated. Therefore, power consumption can be reduced during the operation of the location determination module 101.

If, as the user terminal enters a shadowing area, the GPS module is switched to another module (e.g. the WPS module, the cell-based location information providing module, or the sensor-based location information providing module) in the location determination module 101, a jumping phenomenon may occur in view of the difference in characteristics between the GPS module and the other module. In this context, location information is estimated based on GPS location information stored prior to the entry into the GPS shadowing area and the estimated location information is used before the module switching in the location information providing method according to the exemplary embodiment of the present invention. Consequently, the jumping phenomenon can be prevented.

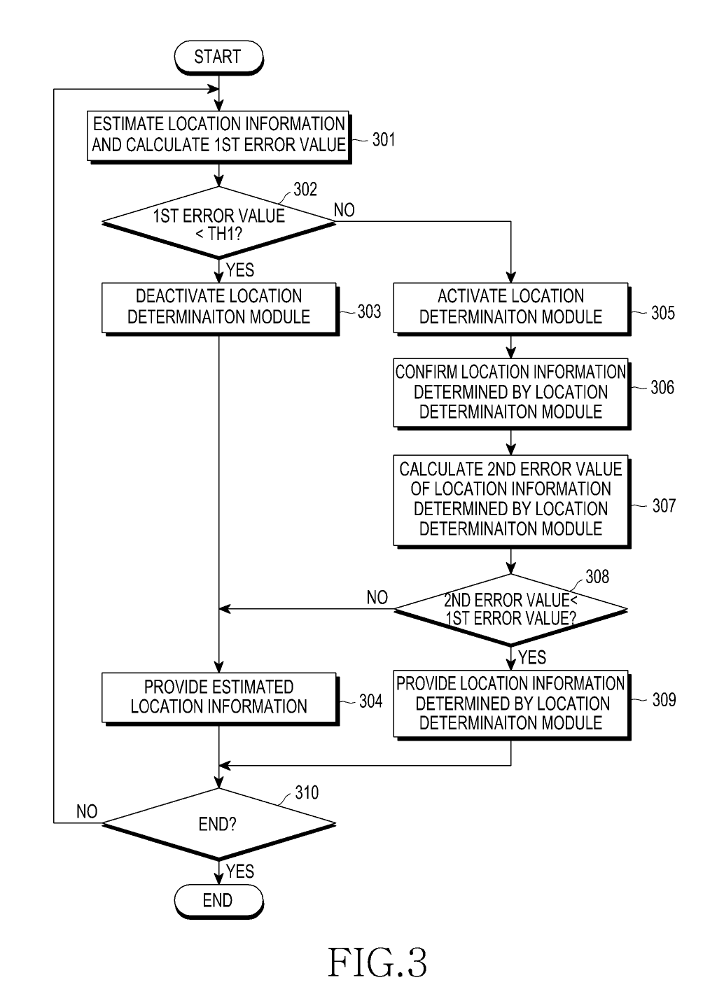

FIG. 3 is a flowchart illustrating a method for providing location information according to another exemplary embodiment of the present invention. The exemplary embodiment illustrated in FIG. 3 is different from the exemplary embodiment illustrated in FIG. 2 in that a step for comparing an error value of location information determined by the location determination module 101 and providing location information according to the comparison result is further performed.

More specifically, steps 301 to 306 are substantially identical to steps 201 to 206 illustrated in FIG. 2 and steps 310 and 309 are substantially identical to steps 208 and 207 illustrated in FIG. 2, respectively.

Referring to FIG. 3, location information is estimated and an error value of the estimated location information (referred to as a first error value) is estimated in step 301. In step 302, the first error value is compared with a predetermined first threshold TH1. If the first error value is smaller than the first threshold TH1 in step 302, the controller 104 outputs a control signal for deactivating the location determination module 101 and the location determination module 101 is deactivated in response to the control signal in step 303. Subsequently, the controller 104 confirms the location information estimated in step 301 and provides the confirmed location information in step 304.

On the contrary, if the first error value is equal to or larger than the first threshold TH1 in step 302, the controller 104 outputs a control signal for activating the location determination module 101 and thus the location determination module 101 is activated in response to the control signal in step 305.

The control signal may be provided directly to the location determination module 101 to thereby control the operation of the location determination module 101. Additionally, the control signal may be provided to the power supply 108 so that the power supply 108 may supply or cut power to the location determination module 101.

If the location determination module 101 is activated in step 305, the controller 104 confirms location information received from the location determination module 101 in step 306.

During the determining of the location information, the location determination module 101 may calculate an error value of the determined location information (hereinafter, referred to as a second error value). Thus, the second error value received from the location determination module 101 is checked in step 307.

The location determination module 101 may include a plurality of modules and the plurality of modules may operate simultaneously. For example, the GPS module and the WPS module may operate at the same time so as to provide GPS-based location information (e.g., GPS location information) and an error value of the GPS location information, and Wi-Fi based location information (e.g., Wi-Fi location information) and an error value of the Wi-Fi location information. In an exemplary implementation, the second error value is set to the smaller error value between error values received from a plurality of modules (e.g., the smaller error value between the error value of the GPS location information and the error value of the Wi-Fi location information). While the plurality of modules are described as the GPS module and the WPS module, this is purely exemplary. Thus, the plurality of modules may be other modules than the GPS and WPS modules, as far as the modules can determine location information.

In step 308, the second error value is compared with the first error value. If the second error value is smaller than the first error value in step 308, this implies that the location information determined by the location determination may be more accurate than the estimated location information. Therefore, the location information determined by the location determination is output in step 309.

On the contrary, if the second error value is equal to or larger than the first error value in step 308, this implies that the estimated location information may be more accurate than the location information determined by the location determination. Therefore, the procedure goes to step 304.

The location information provided in step 304 or 309 may be used for an application executed by the controller 104 or transmitted to a communication network, for use in a location information-based service.

In step 310, it is determined whether the application or the location information-based service is in progress. While the application or the location information-based service is in progress, steps 301 to 309 are repeated.

In the location information providing method illustrated in FIG. 3, before step 301, the controller 104 may further determine whether the user terminal is located in a shadowing area by checking the reception sensitivity of location information received from the GPS module of the location determination module 101, for example, the number of available GPS satellites and the received signal strengths of GPS satellite signals. Steps 301 to 310 may be performed only if the user terminal is located in a shadowing area.

Meanwhile, it may be determined from information received from the motion sensor unit 102 whether the user is moving. While the user is stationary, the location determination module 101 may unnecessarily operate. In this context, another exemplary embodiment of the present invention provides a method for determining whether a user is moving and controlling activation of the location determination module according to the determination.

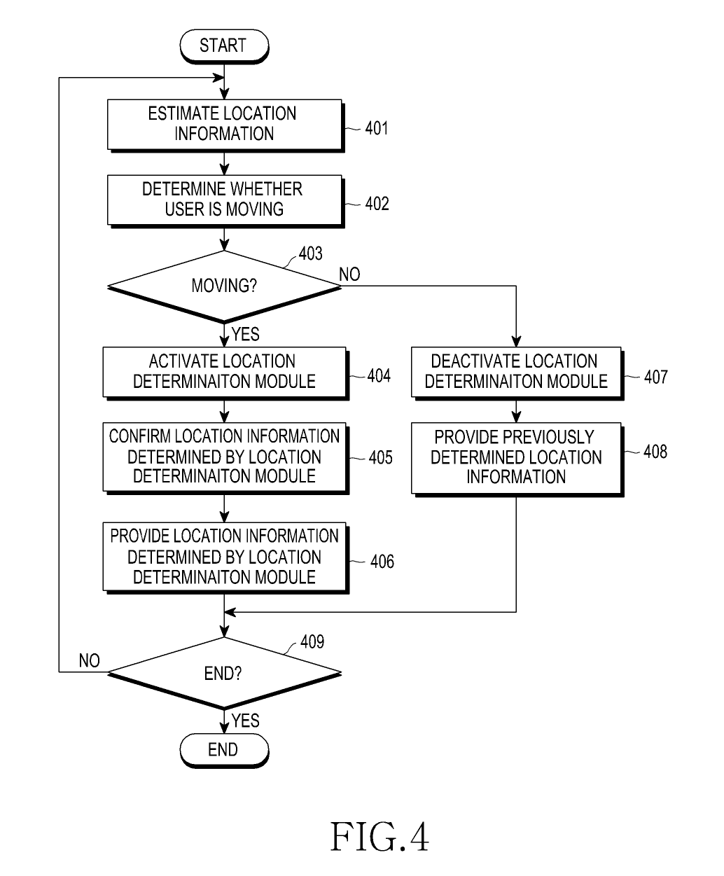

FIG. 4 is a flowchart illustrating a method for providing location information according to another exemplary embodiment of the present invention.

Referring to FIG. 4, the location information providing method includes step 401 for estimating location information using a sensor for sensing a motion of the user, step 402 for determining whether the user is moving, and steps 403 to 408 for controlling activation of the location determination module 101 according to the determination.

Step 401 may be performed in substantially the same manner as step 201 illustrated in FIG. 2. That is, the movement state of the user terminal is determined and the velocity of the user terminal is calculated, using information received from the acceleration sensor. The heading of the user is determined using data validity information and azimuth angle information received from the geomagnetic sensor. Then, current location information about the user is estimated by considering the azimuth angle information and the velocity information with respect to the estimated heading of the user in already stored GPS location information.

Step 402 may be performed by the controller 104 in the location information providing apparatus. More specifically, the controller 104 determines whether the user is moving by analyzing data received from the acceleration sensor or the gyro sensor. For example, if a variation in measurement data of the acceleration sensor or the gyro sensor is smaller than a predetermined threshold or if the variation of the measurement data is kept smaller than the predetermined threshold for at least a predetermined time, the controller 104 determines that the user is not moving. Otherwise, the controller 104 determines that the user is moving.

If it is determined that the user is moving in step 403, the location determination module 101 is activated in step 404. If it is determined that the user is stationary in step 403, the location determination module 101 is deactivated in step 407. The activation or deactivation of the location determination module 101 may be performed by means of a control signal output from the controller 104. That is, the control signal may be provided directly to the location determination module 101 to thereby control activation or deactivation of the location determination module 101. Additionally, the control signal may be provided to the power supply 108 so that the power supply 108 may supply or cut power to the location determination module 101 to activate or deactivate the location determination module 101.

If the location determination module 101 is activated in step 404, the controller 104 confirms location information received from the location determination module 101 in step 405 and provides the confirmed location information in step 406. On the other hand, if the location determination module 101 is deactivated in step 407, the controller 104 confirms location information that was determined by the location determination module 101 or the location information estimator 103 and previously stored and provides the confirmed location information in step 408.

The location information provided in step 406 or 408 may be used for an application executed by the controller 104 or transmitted to a communication network, for use in a location information-based service.

In step 409, it is determined whether the application or the location information-based service is in progress. While the application or the location information-based service is in progress, steps 401 to 408 are repeated.

In the location information providing method illustrated in FIG. 4, before step 401, the controller 104 may further determine whether the user terminal is located in a shadowing area by checking the reception sensitivity of location information received from the GPS module of the location determination module 101, for example, the number of available GPS satellites and the received signal strengths of GPS satellite signals. Steps 401 to 409 may be performed only if the user terminal is located in a shadowing area.

In a location information providing method according to a further exemplary embodiment of the present invention, a method for controlling activation of the location determination module according to the error value of estimated location information is used in combination with a method for activation of the location determination module according to whether a user is moving or not.

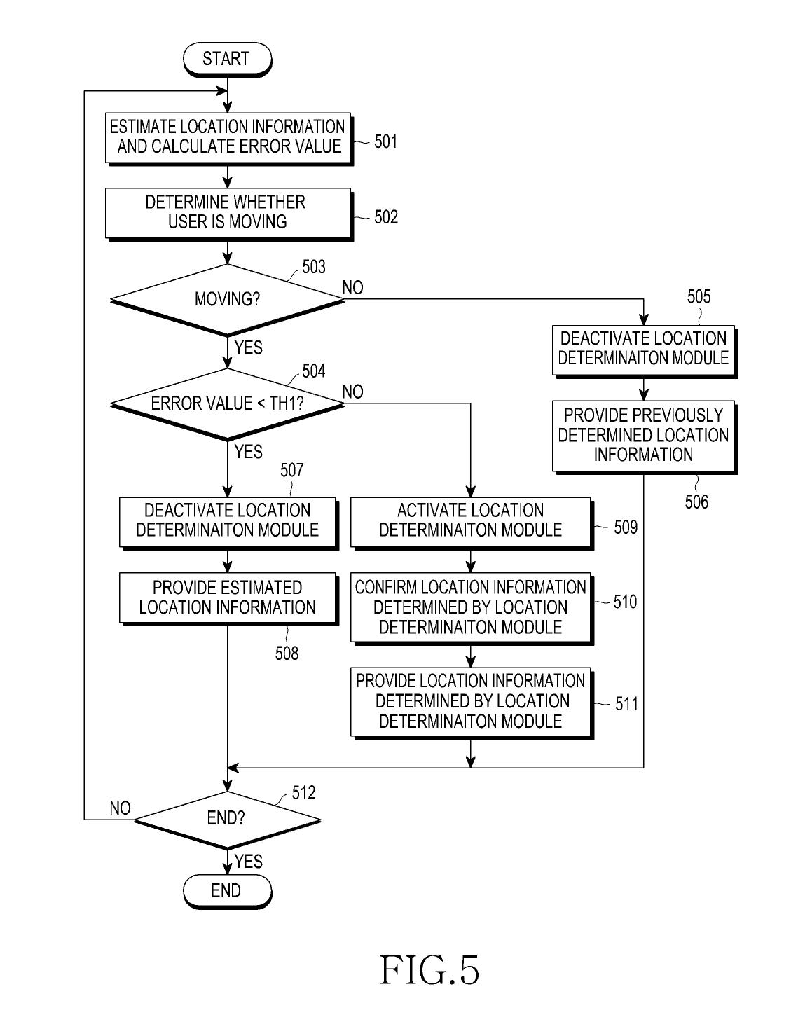

FIG. 5 is a flowchart illustrating a method for providing location information according to a further exemplary embodiment of the present invention.

Referring to FIG. 5, an error value of estimated location information is determined in step 501.

Step 501 may be performed in substantially the same manner as step 201 illustrated in FIG. 2. More specifically, location information may be estimated using information received at every predetermined interval from the acceleration sensor and the geomagnetic sensor. That is, the location information estimator 103 determines the movement state of the user terminal and calculates the velocity of the user based on information received from the acceleration sensor. In addition, the location information estimator 103 determines the heading of the user based on data validity information and azimuth angle information received from the geomagnetic sensor. Then, the location information estimator 103 estimates current location information about the user by considering the azimuth angle information and velocity information with respect to the estimated heading of the user in already stored GPS information. The error value of the estimated location information is estimated, taking into account auxiliary location information including information about the movement state of the user terminal, the data validity of the geomagnetic sensor, and the velocity of the user or user terminal. The error value may be an accumulation of errors that may be produced during estimating of the location information. The error value may be calculated using the movement state of the user terminal, the validity of a geomagnetic sensor output, the velocity of the user, the velocity variance of the user, a time interval between error calculations, the error of each sensor, a moving time of the user in a shadowing area, a variation in the angular velocity of the gyro sensor, and an altitude variation of the user.

Steps 502 and 503 may be performed in substantially the same manner as steps 302 and 303 illustrated in FIG. 3. For example, if a variation in measurement data of the acceleration sensor or the gyro sensor is smaller than a predetermined threshold or if the variation of the measurement data is kept smaller than the predetermined threshold for a predetermined time or longer, the controller 104 determines that the user is not moving. Otherwise, the controller 104 determines that the user is moving.

If it is determined that the user is moving in step 503, the error value calculated in step 501 is compared with a predetermined threshold TH1 in step 504. On the other hand, if it is determined that the user is not moving in step 503, the location determination module 101 is deactivated in step 505.

When the location determination module 101 is deactivated in step 505, the controller 104 confirms previous location information that was determined by the location determination module 101 or the location information estimator 103 and then stored and provides the previous location information in step 506. The previous location information may be location information that was stored by the location determination module 101 or the location information estimator 103.

Steps 504, 507, 508, 509, 510, and 511 are substantially identical to steps 202 to 207 illustrated in FIG. 2. To be more specific, the controller 104 compares the error value received from the location information estimator 103 with the predetermined threshold TH1 in step 504. If the error value is smaller than the threshold TH1 in step 504, the controller 104 outputs a control signal for deactivating the location determination module 101 and thus the location determination module 101 is deactivated in response to the control signal in step 507. On the contrary, if the error value is equal to or larger than the threshold TH1 in step 504, the controller 104 outputs a control signal for activating the location determination module 101 and thus the location determination module 101 is activated in response to the control signal in step 509. The activation or deactivation of the location determination module 101 may be performed by means of a control signal output from the controller 104. That is, the control signal may be provided directly to the location determination module 101 to thereby control the operation of the location determination module 101. Additionally, the control signal may be provided to the power supply 108 so that the power supply 108 may supply or cut power to the location determination module 101.

If the location determination module 101 is deactivated in step 507, the controller 104 confirms and provides the location information estimated by the location information estimator 103 in step 508. On the other hand, if the location determination module 101 is activated in step 509, the controller 104 confirms location information received from the location determination module 101 in step 510 and provides the confirmed location information in step 511.

The location information provided in step 506, 508, or 511 may be used for an application executed by the controller 104 or transmitted to a communication network, for use in a location information-based service.

In step 512, it is determined whether the application or the location information-based service is in progress. While the application or the location information-based service is in progress, steps 501 to 511 are repeated.

In the location information providing method according to the exemplary embodiment of the present invention, before step 501, the controller 104 may further determine whether the user terminal is located in a shadowing area by checking the reception sensitivity of location information received from the GPS module of the location determination module 101, for example, the number of available GPS satellites and the received signal strengths of GPS satellite signals. Steps 501 to 512 may be performed only if the user terminal is located in a shadowing area.

As is apparent from the above description of the exemplary method and apparatus for determining location information according to the present invention, power consumption can be remarkably reduced for determining location information.

In addition, if a GPS shadowing area in which a user terminal is located has a relatively high GPS positioning accuracy, the location of the user terminal is estimated while the GPS module is off. Thus, power consumption can be significantly reduced for determining location information.

It will be appreciated that exemplary embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are exemplary embodiments of machine-readable storage that are suitable for storing a program or programs comprising instructions that, when executed, implement exemplary embodiments of the present invention. Accordingly, exemplary embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and exemplary embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for providing location information, the method comprising:
estimating location information;
calculating an error value of the estimated location information;
controlling activation of a location determination module according to the error value; and
providing location information using at least one of the estimated location information and location information determined by the location determination module.

2. The method of claim 1, wherein the error value calculation comprises calculating the error value of the estimated location information using at least one of a movement state of a user terminal, validity of a geomagnetic sensor output, a velocity of a user, a velocity variance of the user, a time interval between error value calculates, an error of each sensor, a moving time of the user in a shadowing area, and an angular velocity variation of a gyro sensor.

3. The method of claim 1, wherein the controlling of activation of the location determination module comprises:
comparing the error value with a predetermined first threshold; and
deactivating the location determination module, if the error value is smaller than the predetermined first threshold.

4. The method of claim 3, wherein the provision of location information comprises providing the estimated location information, if the error value is smaller than the predetermined first threshold.

5. The method of claim 1, wherein the controlling of activation of the location determination module comprises:
comparing the error value with a predetermined first threshold; and
activating the location determination module, if the error value is equal to or larger than the predetermined first threshold.

6. The method of claim 5, wherein the provision of location information comprises providing the location information determined by the location determination module, if the error value is equal to or larger than the predetermined first threshold.

7. The method of claim 1, wherein the location determination module includes a Global Positioning System (GPS) module for receiving location information from a GPS and providing the received location information, a Wireless Fidelity (Wi-Fi) Positioning System (WPS) module for determining location information using wireless Access Point (AP) information received by Wi-Fi, a cell-based location information providing module for providing location information based on a cell of a mobile communication network, and a sensor-based location information providing module.

8. The method of claim 1, further comprising:
determining whether a user is moving using a sensor unit that senses a motion of the user; and
controlling activation of the location determination module according to whether the user is moving.

9. The method of claim 8, wherein the determining of whether the user is moving comprises:
determining a time period in which a value received from the sensor unit is equal to or smaller than a predetermined value;
comparing the time period with a predetermined second threshold; and
deactivating the location determination module, if the time period is larger than the predetermined second threshold.

10. The method of claim 8, wherein the determining of whether the user is moving comprises:
determining a time period in which a value received from the sensor unit is kept equal to or smaller than a predetermined value;
comparing the time period with a predetermined second threshold; and
activating the location determination module, if the time period is equal to or smaller than the predetermined second threshold.

11. The method of claim 8, wherein the sensor unit includes an acceleration sensor and an angular velocity sensor and the location information estimation comprises estimating location information about a user using information received from the acceleration sensor and the angular velocity sensor.

12. The method of claim 1, wherein the controlling of activation of the location determination module comprises controlling power supply to the location determination module.

13. An apparatus for providing location information, the apparatus comprising:
a location determination module for determining location information;
a motion sensor unit including at least one sensor for generating motion information representing a motion of a user;
a location information estimator for estimating location information using the motion information received from the motion sensor unit and for calculating an error value of the estimated location information; and
a controller for controlling activation of a location determination module according to the error value and for controlling provision of location information using at least one of the location information received from the location information estimator and the location information determined by the location determination module.

14. The apparatus of claim 13, wherein the error value of the estimated location information is calculated using at least one of a movement state of a user terminal, validity of a geomagnetic sensor output, a velocity of a user, a velocity variance of the user, a time interval between error value calculates, an error of each sensor, a moving time of the user in a shadowing area, and an angular velocity variation of a gyro sensor.

15. The apparatus of claim 13, further comprising a power supply for supplying power to at least one of the location determination module, the motion sensor unit, and the location information estimator,
wherein the controller controls activation of the location determination module by controlling power supply to the location determination module.

16. The apparatus of claim 13, wherein the controller controls activation of the location determination module by comparing the error value with a predetermined first threshold, and deactivating the location determination module if the error value is smaller than the predetermined first threshold.

17. The apparatus of claim 16, wherein the controller controls the provision of the location information by providing the estimated location information if the error value is smaller than the predetermined first threshold.

18. The apparatus of claim 13, wherein the controller controls activation of the location determination module by comparing the error value with a predetermined first threshold, and activating the location determination module, if the error value is equal to or larger than the predetermined first threshold.

19. The apparatus of claim 18, wherein the controller controls the provision of the location information by providing the location information determined by the location determination module if the error value is equal to or larger than the predetermined first threshold.

20. The apparatus of claim 13, wherein the location determination module includes a Global Positioning System (GPS) module for receiving location information from a GPS and providing the received location information, a Wireless Fidelity (Wi-Fi) Positioning System (WPS) module for determining location information using wireless Access Point (AP) information received by Wi-Fi, a cell-based location information providing module for providing location information based on a cell of a mobile communication network, and a sensor-based location information providing module.
